(19) United States
(12) Patent Application Publication
(10) Pub. No.: US 2023/0165224 A1
(43) Pub. Date: Jun. 1, 2023

(54) SYSTEMS AND METHODS FOR PROMOTING PRODUCTION OF MALE EMBRYOS IN EGGS

(71) Applicant: OVO TECHNOLOGY LTD., Moshav Kidron (IL)

(72) Inventor: Mohamad HAJ' NASHAT, Kaukab Abu al-Hija (IL)

(21) Appl. No.: 17/912,973

(22) PCT Filed: Mar. 29, 2021
(86) PCT No.: PCT/IL2021/050350

§ 371 Date: Sep. 20, 2022

Related U.S. Application Data
(60) Provisional application No. 63/001,382, filed on Mar. 29, 2020.

(51) Int. Cl. A01K 45/00; A01K 41/04; A01K 41/02

(52) U.S. Cl. CPC A01K 45/007; A01K 41/04; A01K 41/023; A01K 2227/30

(57) ABSTRACT

Provided herein are methods for promoting production of male embryos in avian eggs, utilizing a composition which includes Ginseng extract, Vitamin D and/or folic acid. Further provided are systems for delivering one or more substances for promoting the production of male embryos in avian eggs via a humidity unit of an incubator in which the fertilized avian eggs are incubated.

### FIELD OF THE INVENTION

Embodiments of the disclosure relate to systems and methods for promoting production of male embryos of oviparous animals.

### BACKGROUND

In animal production markets such as the poultry market, the ability to control or affect the sex of the animals may enhance production and efficiency of production.

For example, in egg laying operations, only hens or females are desired. Thus, when a flock of birds is born, only female birds are retained, and often male birds are euthanized or otherwise disposed of. Because males and females are born at an approximate 50/50 sex ratio, approximately half of all avian born at such operations are thus lost and unproductive or provide a diminished production. Methods for the manipulation of hens such that they preferentially produce more female or male offspring has the potential to increase efficacy and productivity in the poultry industry.

Growing costs of male birds are generally lower by about 11% as compared to female birds, whereas male birds provide over 13% more meat.

There is thus a need in the art for systems and methods for efficiently and cost effectively controlling, promoting, or otherwise influencing the sex of the birds before hatching, in order to selectively produce more male birds, and thereby increase production and decrease waste and costs.

### SUMMARY

The following embodiments and aspects thereof are described and illustrated in conjunction with systems, tools and methods which are meant to be exemplary and illustrative, not limiting in scope.

Provided herein are advantageous systems and methods for enhancing, promoting and/or affecting the production/formation of male embryos in avian eggs, in a safe, efficient and cost-effective manner. In some embodiments, the systems and methods advantageously include the use of a composition which includes Ginseng extract and optionally vitamin D and/or folic acid, that can effectively and safely promote/enhance production of male embryos (over female embryos).

In some embodiments, there is provided an advantageous method for promoting production of male embryos in avian eggs, the method includes the steps of:

Incubating a plurality of fertilized avian eggs to promote hatching of the fertilized eggs; contacting the avian eggs with a composition which includes Ginseng extract, to thereby promote production of male embryos in the avian fertilized eggs.

According to some embodiments, there is provided a method for promoting production of male embryos in avian eggs, the method comprising the steps of: incubating a plurality of fertilized avian eggs to promote hatching of the fertilized eggs; and contacting the fertilized avian eggs with a composition comprising Ginseng extract; thereby promoting production of male embryos in the avian fertilized eggs.

According to some embodiments, the composition may further include Vitamin D and/or folic acid.

According to some embodiments, the fertilized eggs are chicken eggs.

According to some embodiments, the incubating is performed for a duration of about 21 days.

According to some embodiments, the contacting is selected from spraying, spreading, brushing, injecting or dipping the eggs.

According to some embodiments, the contacting is performed for one or more predetermined time periods during incubation.

According to some embodiments, a duration of a predetermined time period may range between about an hour to about 14 hours.

According to some embodiments, a pause (interval) between two successive predetermined time periods may range between about 1 hour to about 5 days.

According to some embodiments, the incubating may be performed under at least one controlled environmental condition selected from humidity and temperature.

According to some embodiments, the humidity may range from about 40% to about 80%.

According to some embodiments, the humidity may be between about 35-65%.

According to some embodiments, the humidity may be between about 45-55%.

According to some embodiments, the temperature may range from about 36 ° to 38° C.

According to some embodiments, the resulted percentage of male offspring is over about 50%. According to some embodiments, the resulted percentage of male offspring is over about 65%. According to some embodiments, the resulted percentage of male offspring is over about 75%.

According to some embodiments, the method may further include contacting the fertilized eggs with a second composition comprising folic acid and/or vitamin D, wherein the second composition is provided during one or more predetermined time periods during the incubation period, concomitantly with, successively or alternating with administration of the composition comprising the Ginseng extract.

According to some embodiments, the method may further include a step of adding a vitamin, a growth hormone, antibiotic agent or any combination thereof, to the fertilized eggs, during incubation. According to some embodiments, the vitamin is vitamin B.

According to some embodiments, the fertilized eggs may be dipped or contacted in a composition which includes Ginseng extract prior to the step of incubation.

According to some embodiments, the fertilized eggs may be dipped/contacted in a composition including: Ginseng extract, Vitamin D, folic acid, or any combination thereof, prior to the step of incubation.

According to some embodiments, there is provided a method for contacting avian eggs with a composition comprising one or more substances during incubation in an incubator, the method includes the steps of: incubating a plurality of fertilized eggs in an incubator; and delivering the composition into the incubator via a humidity unit of the incubator to thereby facilitate the contacting of the composition with the avian eggs.

According to some embodiments, contacting facilities the delivery of the one or more substances into the fertilized eggs.

According to some embodiments, the one or more substances may be selected from: one or more agents capable of promoting male or female production, a vitamin, a growth hormone, antibiotic agent, or any combination thereof.

According to some embodiments, there is provided a system for contacting avian eggs with a composition comprising one or more substances during incubation in an incubator, the system includes: an incubator for incubating fertilized avian eggs under environmental conditions configured to allow the hatching of the fertilized eggs; a humidity unit configured to control the humidity in the incubator; a ventilation unit associated with the humidity unit, said ventilation unit includes one or more sprinklers/sprayers configured to deliver a substance into the incubator via the humidity unit when activated; and a control unit configured to control operation of the one or more sprinklers and to control the release of the substance into the humidity unit.

According to some embodiments, the system may further include a soundwave transmitter configured to transmit a variable frequency ranging from about 100 Hz to 1000 Hz during incubation to promote production of male embryos in the fertilized egg.

According to some embodiments, the control unit may be further configured to control the temperature and/or the humidity in the incubator during incubation.

According to some embodiments, the ventilation unit may be configured to essentially evenly spray/spread/apply the plurality of incubated eggs with the substance when the sprinkler is activated. To thereby contact the eggs with the substance(s).

T According to some embodiments, the ventilation unit may be connected to one or more containers comprising a substance.

According to some embodiments, each container may include a similar or different substance, combination of substances and/or concentration of substances.

According to some embodiments, the substance in the container may be in the form of a capsule.

According to some embodiments, the control unit is configured to control the release of the capsule’s contents to the ventilation unit.

According to some embodiments, the substance may be selected from: Ginseng extract, Folic acid, Vitamin D, a vitamin other than Vitamin D, a growth hormone, an antibiotic agent, or any combination thereof. Each possibility is a separate embodiment.

According to some embodiments, there is provided a formulation for promoting production of male embryos in avian eggs, the formulation includes Ginseng extract. According to some embodiments, the formulation may further include vitamin D and/or folic acid. According to some embodiments, the Ginseng extract is a Korean red Ginseng extract.

According to some embodiments, the ratio between the Ginseng extract and vitamin D may be between about 5:1 to between about 1:2 w/w.

According to some embodiments, the ratio between the Ginseng extract and the folic acid is between about 10:1 to between about 1:10 w/w.

According to some embodiments, the formulation may be in the form of powder, solution, liquid, dispersion, spray, or capsulated in a capsule.

According to some embodiments, the capsule is configured to release a substance to a humidity unit of an incubator of fertilized avian eggs.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. It is intended that the embodiments and figures disclosed herein are to be considered illustrative rather than restrictive. The figures are listed below:

FIG. 1 schematically depicts a system for promoting production of male embryos in fertilized eggs, according to an exemplary embodiment of the current invention; and

FIG. 2 schematically shows steps in a method for promoting production of male embryos in fertilized eggs, according to some embodiments.

### DETAILED DESCRIPTION

Disclosed herein are advantageous systems and methods for promoting the development of male embryos in fertilized eggs by effectively and cost efficiently applying Ginseng extract, vitamin D, or folic acid or any combination thereof to the eggs to thereby promote male embryos development.

In some embodiments, there is provided a method for promoting production of male embryos in avian eggs (inducing female to male sex reversal), the method includes the steps of: incubating a plurality of fertilized eggs to promote hatching of the fertilized eggs; contacting the avian eggs with a composition which includes Ginseng extract and optionally: vitamin D and/or folic acid, to thereby promote production of male embryos in the fertilized avian eggs.

In some embodiments of the invention, each of the compositions comprising Ginseng extract, vitamin D or folic acid or a composition comprising a combination of Ginseng and/or Vitamin D and/or Folic acid, may be applied/contacted with the eggs simultaneously, successively and or intermittently, during the incubation period.

In some embodiments, the fertilized eggs are avian eggs, such as, chicken eggs.

In some embodiments, the step of incubating is performed for a duration of about 21 days.

In some embodiments, the step of incubating is performed for a duration of about 1, 2, 3, 4, 5, 6, 7, 8, 9, 10, 11, 12, 13, 14, 15, 16, 17, 18, 19, 20 or days.

In some embodiments, the humidity in the incubator is between 35-65%. In some embodiments the humidity is between 40-60%. In some embodiments the humidity is between 45-55%.

In some embodiments, the contacting or applying the composition or substances may be selected from: injecting, dipping, spreading, brushing, spraying, and the like, or any combination thereof. Each possibility is a separate embodiment.

In some embodiments, the contacting allows or facilities the entrance of the composition or substances into the egg. In some embodiments, the composition includes a substance or combination of substances capable of affecting male embryos production or female to male sex reversal.

In some embodiments, contacting may be performed at one or more predetermined time periods during incubation. In some embodiments, when different compositions or substances are utilized, the duration of contacting with one substance may be different than the contacting with a second or third substances, or a combination of substances (agents).

In some embodiments, the contacting is spraying, or delivering the substance via humidity unit of the incubator, as detailed herein.

According to some embodiments, for example, without limitation, the folic acid may be applied (for example, by being sprayed) for a period of two, three or four hours followed by two, three or four hours break and so forth during each day for 21 incubation days, wherein the Ginseng extract may be applied (for example, by being sprayed) continuously all over the day.

According to some embodiments, an exemplary protocol may include: Folic acid, dissolved in water is provided (administered) by spraying for two, three or four hours, followed by two, three or four hours break and so forth, during/for 24 hours and every day, whereas ginseng extract is constantly provided (administered) by spraying continually for 24 hours, in a period of 16, 17, 18, 19 or 21 days. In some embodiments, the humidity is about between 40-70%. In some embodiments, the humidity is about between 50-65%. In some embodiments, the humidity is about 55%. In some embodiments, prior to the treatment (i.e., proving of the substances) in the incubator, the fertilized eggs may be dipped in a composition. In some embodiments, the composition may include Ginseng extract and optionally, vitamin D and/or folic acid.

In some embodiments, a duration of a predetermined time period may range between about an hour to about 14 hours. In some embodiments, a duration of a predetermined time period may range between about two hours to about 12 hours.

In some embodiments, a pause between two successive predetermined time periods may range between about 1, 2, 3 or 4 hours to about 1, 2, 3, 4 5 days.

In some embodiments, the incubation is performed under at least one controlled environmental condition selected from humidity and temperature.

In some embodiments, the humidity ranges from about 40%, 45%, 50%, 55%, 60%, 65%, 70%, 75% to 80%. In some embodiments, the humidity ranges from about 35% to about 55%. In some embodiments, the humidity ranges from 40% to 55%. In some embodiments, the humidity is about 55% or about 45%.

In some embodiments, the temperature ranges from about 36° to about 38° C.

In some embodiments, the resulted percentage of male offspring (i.e., male to female percentage) is over about 50%, 55%, 60%, 65%, 70%, 75%, 80%. In some embodiments, the resulted percentage of male offspring is over about 65%. In some embodiments, the resulted percentage of male offspring is over about 75%. In some embodiments, the resulted percentage of male offspring is over about 80%.

In some embodiments, the folic acid and/or the vitamin D may be provided concomitantly with the ginseng extract in a single composition or in separate compositions. In some embodiments, the folic acid and/or the vitamin D may be provided (administered) during one or more predetermined time period during incubation, optionally with the administration of the Ginseng extract. In some embodiments, each of the folic acid, the vitamin D or the Ginseng extract is provided (administered) during one or more predetermined time period during incubation.

According to some embodiments, the delivery (contacting), for example, by spraying of avian eggs with the composition(s) disclosed herein may be conducted or facilitated by delivering the substance or a plurality of substances via a humidity unit of an incubator, as further detailed herein.

In some embodiments, there is provided a method for delivering a substance or a plurality of substances to avian eggs during incubation in an incubator, the method comprising the steps of: incubating a plurality of fertilized eggs in an incubator to promote hatching of the fertilized eggs; spraying the avian eggs with a composition comprising the substance by delivering the substance or a plurality of substances via a humidity unit of the incubator; thereby delivering the substance into the plurality of eggs.

In some embodiments, the substance is one or more agents that are capable of promoting male or female production, a vitamin, a growth hormone, antibiotic agent or any combination thereof.

In some embodiments, the substance or a plurality of substances is administered during one or more predetermined time period during incubation. In some embodiments, each of the substances is administered during one or more predetermined time period during incubation.

In some embodiments, the substance or a plurality of substances may be administered according to an administration regime, that may include for example, but not limited to: the substances in the formulation (for example, Ginseng extract, folic acid and/or Vitamin D), the concentration of the substance(s), the duration of administration, the order of administration, number of administrations, intervals between administrations, and the like, or any combination thereof.

In some embodiments, there is provided a formulation for promoting production of male embryos in avian eggs which includes Ginseng extract.

In some embodiments, there is provided a formulation for promoting production of male embryos in avian eggs which includes Folic acid.

In some embodiments, there is provided a formulation for promoting production of male embryos in avian eggs which includes Vitamin D.

In some embodiments, there is provided a formulation for promoting production of male embryos in avian eggs which includes Ginseng extract, in combination with vitamin D and/or folic acid. Each possibility is a separate embodiment.

In some embodiments, there is provided a formulation for promoting production of male embryos in avian eggs comprising: Ginseng extract in combination with vitamin D and/or folic acid.

In some embodiments, there is provided a combination treatment for promoting production of male embryos in avian eggs, which includes providing Ginseng extract, optionally in combination with vitamin D and/or folic acid. Each possibility is a separate embodiment. In some embodiments, the Ginseng extract is a Korean red Ginseng extract.

In some embodiments, the ratio between the Ginseng extract and vitamin D in the formulation or the combination treatment may be between about 5:1 to between about 1:2 w/w.

In some embodiments, the vitamin D used herein in the methods and the formulation or the combination treatment is a vitamin D3.

In some embodiments, the formulation or the combination treatment is in a form of powder, solution, liquid, dispersion, spray, or capsulated in a capsule.

In some embodiments, the capsule is configured to release an active material to a humidity system of an incubator for incubating fertilized avian eggs.

In some embodiments, there is provided a method for promoting production of male embryos in avian eggs, the method comprising the steps of:

incubating a plurality of fertilized eggs to promote hatching of the fertilized eggs; contacting the avian eggs with the formulation or the combination treatment described herein; thereby promoting production of male embryos in the avian fertilized eggs.

In some embodiments, the step of contacting is by injecting, dipping, spreading, spraying or brushing the eggs with the formulation or the combination treatment.

In some embodiments, the step of contacting may be according to a desired administration regime, that may include for example, but not limited to: the substances in the formulation (for example, Ginseng extract, folic acid and/or Vitamin D), the concentration of the substance(s), the duration of administration, the order of administration, number of administrations, intervals between administrations, and the like, or any combination thereof.

In some embodiments, the conditions of humidity, temperature or sounds are as disclosed herein. In some embodiments, the dipping, injecting or brushing is at one or more predetermined time period during incubation. In some embodiments, a duration of a predetermined time period ranges between one hour to 14 hours. In some embodiments, a pause between two successive predetermined time periods ranges between 1 hour to 5 days.

In some embodiments, the resulted percentage of male offspring is over about 50%, 55%, 60%, 65%, 70%, 75%, 80%. In some embodiments, the resulted percentage of male offspring is over about 75%. In some embodiments, the resulted percentage of male offspring is over about 80%.

In some embodiments, there is provided a system for contacting avian eggs with a composition comprising one or more substances or for applying a composition comprising one or more substances to avian eggs, the system includes: an incubator for incubating fertilized avian eggs under predetermined environmental conditions to promote hatching of the fertilized eggs; a ventilation unit configured to control the humidity of the incubator, wherein the ventilation unit includes one or more sprinklers/sprayers configured to deliver a substance into the incubator via the humidity unit when activated, such that the substance is capable of contacting the eggs; at least one control unit configured to operate the one or more sprinklers and to control the release of the substance into the humidity unit to thereby facilitate the contacting/application of the substance(s) with/to the eggs.

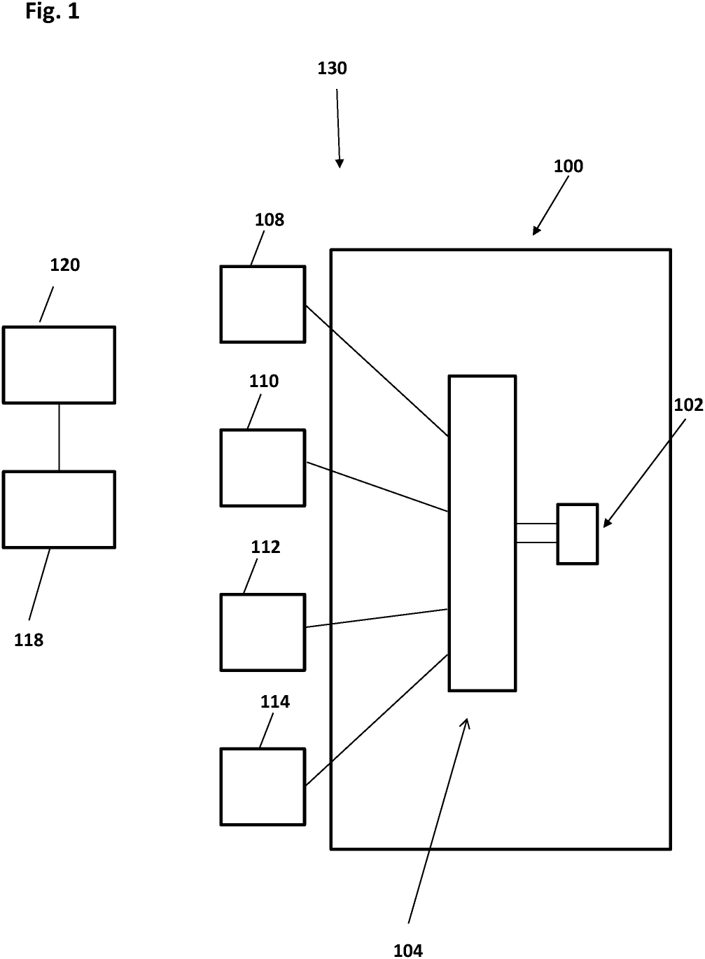

Reference is now made to FIG. 1 in which a system 130 comprising an incubator 100 having a humidity system (unit) 102 linked to by ventilation unit 104 by, for example, a channel, tunnel or pipe. Ventilation unit 104 comprises one or more sprinklers (not shown) configured to deliver a composition comprising a substance (such as for example, ginseng extract, vitamin D or folic acid or any combination thereof) from one or more containers/cells 108, 110, 112, 114 into incubator 100 via humidity system 102, when activated/operating. The one or more containers 108, 110, 112, 114 comprise one or more pumps (not shown). System 130 further comprises a computer 120 capable of managing a control unit 118 configured to control release of the composition comprising one or more substances from one or more of containers 108, 110, 112, 114 according to a certain treatment profile/s. The treatment profile/s or protocol/s may determine the time period and the intermission/break period in which a composition comprising a substance (for example, ginseng extract, vitamin D or folic acid or combination thereof) be delivered from one or more containers 108, 110, 112, 114 to humidity unit 102 via ventilation unit 104. Control unit 118 may further be configured to control (for example, activate/deactivate) one or more additional units of the system, such as, for example, heater/cooler/thermostat, humidifier, etc. so as to ensure a pre-determined temperature, humidity, and the like. According to some embodiments, the treatment profile/s may be modified in accordance with the internal conditions in the incubator, such as, temperature, humidity, presence (for example, percentage, amount) of a composition comprising a substance and the like.

In some embodiments, the system further includes a soundwave transmitter configured to produce/transmit a variable frequency ranging from about 100 Hz to 1000 Hz during incubation and in some embodiments, the controller of the system is further configured to control the temperature and/or the humidity during incubation. In some embodiments, the ventilation unit is configured to essentially evenly spray the plurality of eggs incubated with the substance when the sprinkler is activated. In some embodiments, the ventilation unit is connected to a one or more cells/containers comprising a capsule containing a substance or a plurality of substances. The capsules may contain the same substance or different substances. In some embodiments, the control unit controls a release of the capsule’s contents into the ventilation unit.

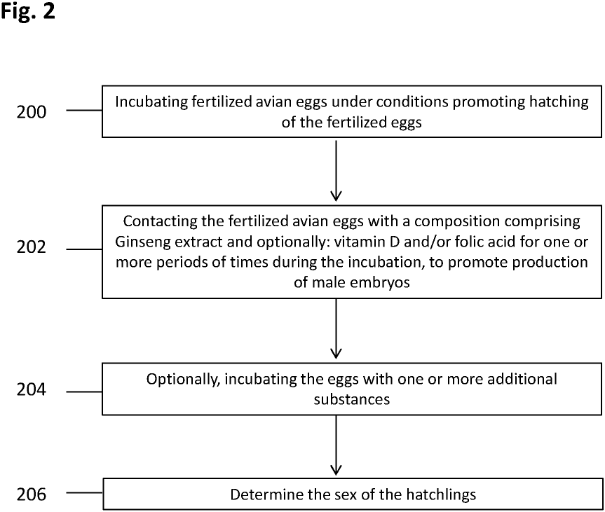

Reference is now made to FIG. 2, which shows step in a method for promoting production of male embryos in avian eggs, according to some embodiments. As shown in FIG. 2, at step 200, the method includes incubating fertilized avian eggs under conditions promoting hatching of the fertilized eggs, such conditions include, for example, controlled temperature and humidity, as well as any other suitable condition (such as, for example, sound, oxygen concentration, CO₂ concentration, and the like). Once the fertilized eggs are incubated, at step 202, a composition which includes male producing promoting substances (agents) are applied to/contacted with the eggs, at a suitable administration regime. In the example shown in FIG. 2, the eggs are contacted with Ginseng extract and optionally with folic acid and/or Vitamin D. The administration regime may include, for example, but not limited to: the substances in the composition (for example, Ginseng extract, folic acid and/or Vitamin D), the concentration of the substance(s), the duration of administration, the order of administration, number of administration, intervals between administrations, and the like, or any combination thereof. At optional step 204, the eggs may be further contacted with one or more additional agents (such as for example, other vitamins (including, for example, Vitamin B), antibacterial agents, growth hormones, and the like). Next, at step 206, at the end of the incubation period, after the eggs have hatched, the sex of the hatchlings is determined, to determine the male percentage. In some embodiments, prior to step 200, the eggs, prior to the beginning of the incubation may be dipped/ spread/brushed with a composition which includes ginseng extract, folic acid, vitamin D, or any combination thereof.

In some embodiments, the folic acid and/or the vitamin D is administered during one or more predetermined time period during incubation optionally with the administration of the Ginseng extract.

In some embodiments, the method further comprises the addition of a vitamin, a growth hormone, antibiotic agent or any combination thereof to the fertilized eggs. The vitamin may be vitamin B and, in some embodiments, vitamin B-12.

In some embodiments, the fertilized eggs are dipped in a composition comprising Ginseng extract; vitamin D or folic acid or any combination thereof prior to the step of incubation.

In some embodiments, there is provided a method for delivering a substance or a plurality of substances to avian eggs during incubation in an incubator, the method comprising the steps of: incubating a plurality of fertilized eggs in an incubator to promote hatching of the fertilized eggs; spraying the avian eggs with a composition comprising the substance or a plurality of substances by delivering the composition via a humidity unit of the incubator; thereby delivering the substance into the plurality of eggs.

In some embodiments, the substance is one or more agents that promote male or female production, a vitamin, a growth hormone, antibiotic agent or any combination thereof.

In some embodiments, there is provided a system comprising: an incubator for incubating fertilized avian eggs under predetermined environmental conditions to promote hatching of the fertilized eggs; a ventilation unit configured to control the humidity of the incubator, wherein the ventilation system comprises one or more sprinklers configured to deliver a substance into the incubator via the humidity unit when activated; at least one control unit configured to operate the one or more sprinklers and to control the release of the substance into the humidity unit.

In some embodiments, the system further comprising a soundwave transmitter configured to transmit a variable frequency ranging from about 100 Hz to 1000 Hz during incubation to promote production of male embryos in the fertilized egg.

In some embodiments, the controller is further configured to control the temperature and/or the humidity during incubation.

In some embodiments, the ventilation unit is configured to essentially evenly spray the plurality of eggs incubated with the substance when the sprinkler is activated.

In some embodiments, the ventilation unit is connected to a one or more containers comprising a capsule containing a substance.

In some embodiments, the control unit controls a release of the capsule’s contents to the ventilation unit.

In some embodiments, there is provided a formulation for promoting production of male embryos in avian eggs comprising Ginseng extract, vitamin D, or folic acid or any combination thereof. In some embodiments, the Ginseng extract is a Korean red Ginseng extract.

In some embodiments, the ratio between the Ginseng extract and vitamin D is between about 5:1 to between about 1:2 w/w.

In some embodiments, the ratio between the Ginseng extract and the folic acid is between about 10:1 to between about 1:10 w/w.

In some embodiments, the formulation is in a form of powder, solution, liquid, dispersion, spray, or capsulated in a capsule. The capsule is, in some embodiments, configured to release an active material to a humidity system of an incubator for incubating fertilized avian eggs.

In some embodiments, there is provided a method for promoting production of male embryos in avian eggs, the method comprising the steps of: incubating a plurality of fertilized eggs to promote hatching of the fertilized eggs; contacting the avian eggs with the composition of the invention thereby promoting production of male embryos in the avian fertilized eggs.

The step of contacting, in some embodiments, is referred herein to injecting, dipping or brushing. In some embodiments, the incubating is performed for a duration of about 21 days.

In some embodiments, the humidity is between 35-65%. In some embodiments, the humidity is between 45-55%. In some embodiments, the spraying or dipping is at one or more predetermined time period during incubation. In some embodiments, a duration of a predetermined time period ranges between one hour to 14 hours. In some embodiments, a pause between two successive predetermined time periods ranges between 1 hour to 5 days. In some embodiments, the incubation is performed under at least one controlled environmental condition selected from humidity and temperature. In some embodiments, the humidity ranges from 40% to 80%. In some embodiments, the temperature ranges from 36° to 38° C. In some embodiments, the resulted percentage of male offspring is above 50%, 65% or 75%.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80 % and 120 % of the given value. According to some embodiments, “about” may specify the value of a parameter to be between 90 % and 110 % of the given value. According to some embodiments, “about” may specify the value of a parameter to be between 95 % and 105 % of the given value.

While a number of exemplary aspects and embodiments have been discussed above, those of skill in the art will recognize certain modifications, permutations, additions and sub-combinations thereof. It is therefore intended that the following appended claims and claims hereafter introduced be interpreted to include all such modifications, permutations, additions and sub-combinations as are within their true spirit and scope.

In the description and claims of the application, each of the words “comprise” “include” and “have”, and forms thereof, are not necessarily limited to members in a list with which the words may be associated.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur in a different order than the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or act or carry out combinations of special purpose hardware and computer instructions.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

### EXAMPLES

### Example 1 - Percentage of Male Hatchlings Resulting From Incubation Of Fertilized Eggs in the Incubating System

The methods and systems described herein above, were experimentally tested for promoting production of male embryos within fertilized eggs. Specifically, a percentage of male hatchlings resulting from incubation of fertilized eggs in the incubating system and under the conditions disclosed herein to promote production of male embryos, was compared to a percentage of male hatchlings resulting from incubation of fertilized eggs in a standard incubating system under standard hatching conditions. Experimental tests were conducted using fertilized eggs of a distinct breed of chickens- i.e. ROSS. fertilized chicken eggs were divided into two groups: a test group and a control group. Fertilized chicken eggs of the test group (‘test group eggs’) and fertilized chicken eggs of the control group (‘control group eggs’) were simultaneously incubated for a period of 21 days.

The test group eggs were incubated in an incubating system which includes a controller for releasing the active material into the humidity unit. During the incubation period the humidity ranges were 45% to 55%, and the incubation temperature was approximately 37° C.-38° C. The dosage regimen was as follows:

Vitamin D and Ginseng extract both at a concentration of 10% were added constantly to the humidity unit during all days of incubation - until day 18. Vitamin B-12 was added three times a week.

Following hatching of the eggs from the test group and the control group, the sex of the hatchlings was determined. As shown in Table 1, the test group eggs of both breeds resulted in a higher percentage of male hatchlings.

TABLE 1

Hatching results of fertilized eggs

| Breed - ROSS 308 | Automatic incubator | |
|---|---|---|
| | Test group | Control group |
| Total eggs | 400 | 400 |
| Hatching rate | 320 (81%) | 332 |
| male percentage | 268 (83%) | 172 |

As can be seen, the male percentage in the experimental group was over 65%.

These results indicate that the method and system described herein may be utilized to promote production of male embryos in fertilized eggs.

### Example 2 - Contacting Incubated Eggs With Korean Ginseng Extract and/or Folic Acid

Test group: Fertilized eggs are dipped in a composition comprising Korean ginseng extract. The fertilized eggs are then transferred to an incubator and are sprayed with folic acid 800 µg/liter and Korean ginseng extract 600 µg/liter according to the following protocol:

Folic acid is administered for 24 hours continuously, followed by break of one day (about 24 hours), and an exposure of 2-4 hours followed by 2-4 hours break every two days. On the days in which folic acid was not administered, Ginseng extract was administered for cycles of 2-4 hours followed by 2-4 hours break.

The eggs are incubated for 21 days under growing conditions which includes Temperature of 37° C., humidity of 54%.

After hatching, the sex of the hatchlings is determined and compared between control group and test group.

### Example 3 - Contacting Incubated Eggs With Korean Ginseng Extract and/or Folic Acid and/or Vitamin D

Test group: Folic acid, in a concentration of 240 µg/litter water is administered/provided by spraying for three hours, followed by three hours break during 24 hours every day. Ginseng extract at a concertation of 400 µg/litter is constantly administered by spraying continually for 24 hours, for a period of 21 days.

For half of the fertilized eggs, prior to the treatment described herein the fertilized eggs are dipped in a composition comprising Ginseng extract, vitamin D or folic acid or any combination thereof.

After hatching, the sex of the hatchlings is determined and compared between control group and test group.

### Example 4 - Effect of Liquid Ginseng Extract on Sexual Reversal

Liquid Ginseng - liquid Red Korean Ginseng is dissolved in DDW before injection. (four different batches/suppliers, referred to Ginseng1, Ginseng2, Ginseng3, Ginseng4).

All materials are prepared on the morning of injection day and kept in syringes in ice until they are injected. About 100 eggs are injected at a time so that the eggs won’t cool off. Every tray of 100 eggs takes approx. 15 minutes from start to finish and the eggs are kept at a room with 28° C. for the entire injection duration.

Eggs in this experiment are from broiler breed and each group is injected on day 4 of incubation with 100 µl of each material. A total of 1500 eggs are used for the experiment (unfertile eggs are removed on the day of injection by candling, so that only fertile eggs are injected).

Liquid Ginseng is injected at the following concentrations to fertilized eggs: -10 mg/egg, 5 mg/egg and 1 mg/egg.

Control: Fadrozole (a known sex reversal agent) is injected at a concentration of 0.15 mg/egg.

The following test groups are included in the experiment:

Group 1 - Control 1 - NTC - untouched eggs - 100 eggs.

Group 2 - Control 2 - injected with DDW - 100 eggs (10 ml) -11 ml DDW.

Group 3 - Liquid Ginseng1 - 1 (25 mg/ml) - 100 eggs (2.5 mg/egg - 250 mg -10 ml) - add 11 ml DDW with 275 mg (275 ul of stock).

Group 4 - Liquid Ginseng1 - 2 (50 mg/ml) -100 eggs (5 mg/egg - 500 mg - 10 ml) - add 11 ml DDW with 550 mg (550 ul of stock).

Group 5 — Liquid Ginseng1 - 3 (10 mg/ml) -100 eggs (1 mg/egg -100 mg -10 ml) - add 11 ml DDW with 110 mg (110 ul of stock).

Group 6 - Liquid Ginseng2 - 1 (25 mg/ml) - 100 eggs (2.5 mg/egg - 250 mg -10 ml) - add 11 ml DDW with 275 mg (275 ul of stock).

Group 7 - Liquid Ginseng2 - 2 (50 mg/ml) -100 eggs (5 mg/egg - 500 mg - 10 ml) - add 11 ml DDW with 550 mg (550 ul of stock).

Group 8 - Liquid Gin2 - 3 (10 mg/ml) - 100 eggs (1 mg/egg - 100 mg - 10 ml) -add 11 ml DDW with 110 mg (110 ul of stock).

Group 9 - Liquid Gin3 - 1 (50 mg/ml) - 100 eggs (5 mg/egg - 250 mg - 10 ml) -add 11 ml DDW with 550 mg (275 ul of stock).

Group 10 - Liquid Gin3 - 2 (100 mg/ml) -100 eggs (10 mg/egg - 500 mg - 10 ml) -add 11 ml DDW with 1100 mg (550 ul of stock).

Group 11 - Liquid Gin3 - 3 (20 mg/ml) - 100 eggs (2 mg/egg - 100 mg - 10 ml) -add 11 ml DDW with 220 mg (110 ul of stock).

Group 12 - Liquid Gin4 - 1 (25 mg/ml) -100 eggs (2.5 mg/egg - 250 mg - 10 ml) -add 11 ml DDW with 275 mg (275 ul of stock).

Group 13 - Liquid Gin4 - 2 (50 mg/ml) - 100 eggs (5 mg/egg - 500 mg - 10 ml) -add 11 ml DDW with 550 mg (550 ul of stock).

Group 14 - Liquid Gin4 - 3 (10 mg/ml) - 100 eggs (1 mg/egg - 100 mg - 10 ml) -add 11 ml DDW with 110 mg (110 ul of stock).

Group 15- Fadrozole -0.15 mg/egg - 100 eggs (15 mg- 10 ml)-add 11 ml DDW with 16.5 mg Fadrozole.

Eggs are disinfected with 70% EtOH prior to injection and holes are made with the modified egg piercer only after EtOH has dried. After every 10-20 eggs, the piercer is disinfected with 70% EtOH. Eggs are injected into the yolk using a 12.7 insulin syringe. Each 1ml syringe is used for 10 eggs only and is not recycled.

On day 18, eggs are monitored for fertility and toxicity of the materials and surviving eggs are transferred into hatching trays for hatching according to the different groups.

Surviving chicks are then monitored for sexual reversal using the following methods:

Feathering - animals are sexed based on their feathers.

Comb - animals are reared and monitored for comb development.

Dissection - All of females are dissected to determine the phenotypic sexual state of the animal.

1-41. (canceled)

42. A method for promoting production of male embryos in avian eggs, the method comprising the steps of:
incubating a plurality of fertilized avian eggs to promote hatching of the fertilized eggs; and
contacting the fertilized avian eggs with a composition comprising Ginseng extract;
thereby promoting production of male embryos in the avian fertilized eggs.

43. The method of claim 42, wherein the composition further comprises Vitamin D and/or folic acid.

44. The method of claim 42, wherein said fertilized eggs are chicken eggs and wherein said incubating is performed for a duration of about 21 days.

45. The method of claim 42, wherein contacting is selected from spraying, spreading, brushing, injecting or dipping the eggs.

46. The method of claim 42, wherein contacting is performed for one or more predetermined time periods during incubation.

47. The method of claim 46, wherein a duration of a predetermined time period ranges between an hour to 14 hours.

48. The method of claim 46, wherein a pause between two successive predetermined time periods ranges between about 1 hour to about 5 days.

49. The method of claim 42, wherein said incubating is performed under at least one controlled environmental condition selected from humidity and temperature.

50. The method of claim 49, wherein the humidity ranges from about 40% to about 80%.

51. The method of claim 49, wherein the temperature ranges from 36° to 38° C.

52. The method of claim 42, wherein the resulted percentage of male offspring is over about 50%.

53. The method of claim 52, wherein the resulted percentage of male offspring is over about 65%.

54. The method of claim 52, wherein the resulted percentage of male offspring is over about 75%.

55. The method of claim 42, further comprising contacting the fertilized eggs with a second composition comprising folic acid and/or vitamin D, wherein the second composition is provided during one or more predetermined time periods during the incubation period, concomitantly with, successively or alternating with administration of the composition comprising the Ginseng extract.

56. The method of claim 42, wherein the method further comprises a step of adding a vitamin, a growth hormone, antibiotic agent or any combination thereof to the fertilized eggs.

57. The method of claim 56, wherein the vitamin is vitamin B.

58. The method of claim 42, wherein the fertilized eggs are dipped in a composition comprising: Ginseng extract, Vitamin D, folic acid, or any combination thereof, prior to the step of incubation.

59. A formulation for promoting production of male embryos in avian eggs, the formulation comprising Ginseng extract.

60. The formulation of claim 59, further comprising vitamin D and/or folic acid.

61. The formulation of claim 60, wherein the Ginseng extract is a Korean red Ginseng extract.
